(19) United States
(12) Patent Application Publication
(10) Pub. No.: US 2015/0172247 A1
(43) Pub. Date: Jun. 18, 2015

(54) System And Method For Method For Controlling A Lifespan Of A Message Sent From Mobile Devices

(71) Applicants: John Anthony Taglioli, Los Angeles, CA (US); Jade Ella Taglioli, Bringelly (AU)

(72) Inventors: John Anthony Taglioli, Los Angeles, CA (US); Jade Ella Taglioli, Bringelly (AU)

(21) Appl. No.: 14/628,208

(22) Filed: Feb. 20, 2015

Related U.S. Application Data
(60) Provisional application No. 61/943,062, filed on Feb. 21, 2014.

(51) Int. Cl. H04L 12/58

(52) U.S. Cl. CPC H04L 51/18

(57) ABSTRACT

A computer implemented messaging system for mobile devices comprising a messaging system operable on the sender and receiver devices, the messaging system comprising: an input module on the sender device, configurable by a user of the sender device to select between at least two options for sending a message through the messaging system to the receiver device, the options comprising: automatically deleting the message after a predetermined amount of time the message is displayed either continuously or intermittently on the receiver device; and storing the message on the receiver device until a user of the receiver device deletes the message. The messaging system is configured to send a message to the sender device if the option to automatically delete the message after a predetermined amount of time is selected and the message is copied on the receiver device before the message is deleted.

### CROSS-REFERENCES TO RELATED APPLICATIONS

The present application claims priority from U.S. Provisional Application Ser. No. 61/943,062 filed on Feb. 21, 2014, which is hereby incorporated herein by reference in its entirety.

### TECHNICAL FIELD

The present invention, in some embodiments thereof, relates to a messaging system for controlling the lifespan of messages displayed on receiving devices.

### BACKGROUND OF THE INVENTION

There are many deletion solutions on the market today that deal with predominately text messaging. These methods attempt to deal with the message after it has been received on the receiver's device with some mixed results. There are other methods that allow the sender to set the lifespan of the SMS and receive confirmation of the deletion once it has been read. Whatever method is used there is no guarantee that before it is erased that it has not been copied and saved on the recipient's hardware or device, before sending it onto third parties without the sender's permission or knowledge.

The present invention relates to the delivery of an MMS (photo, video, voice or text to a recipient who has an account and is a member of a Cloud based Social network platform, (may also be housed in a dedicated remote server) and acts on instructions sent by the sender to the social network provider using a Smart Phone, Tablet or Touch Screen Computer or devices that act in the same manner. The method initiates instructions to the provider that will direct the provider: to erase the MMS from the recipients cloud based social network personal account once it has been viewed; or allow the MMS to be saved on their cloud based social network personal account.

The present invention may optionally alert the sender of a breach, if the recipient attempts to copy or allow third parties receive and view a message directed to be erased.

Social networks have become part of the fabric of our society today, bringing together millions of people both young and old sharing their day to day lives together under the one umbrella. With the advent of these networks, privacy has become the number one issue.

Members of these social networks post information on these networks with no options available to control what happens to the information or material sent, once it has been posted. The provider has very little interest unless threatened with legal action in most cases to do anything about potentially harmful material sent to other members in good faith, only to see it posted to third parties without the senders permission or knowledge.

There are social network providers that erase material after it has been viewed as their only option, and while this has been popular it has been left vulnerable to screen grabs where the recipient copies the material without the sender's knowledge before it has been erased.

There is a need in the social network space for the conveying of MMS whereby the sender can take charge and have choices as to whether the MMS is erased after being viewed or allowed to be saved by the recipient. There is also a desperate need to notify the sender and network provider of any attempt to screen grab or copy an MMS that is instructed by the sender to be erased, and be informed of the breach in real time.

### BRIEF SUMMARY OF EMBODIMENTS OF THE INVENTION

(1) In a variant, a computer implemented method for controlling a lifespan of a message sent from mobile devices, wherein the devices comprise a processor and a non transitory computer readable medium, the method comprises: inputting a message into a sender device; selecting a lifespan for the message, the lifespan comprising a predetermined time the message is displayable at a receiver device, wherein the selection of the lifespan is performed on the sender device; sending the message through a messaging system; receiving the message on a receiver device from the messaging system; and displaying the message on the receiver device in accordance with the selected lifespan for the message. The messaging system deletes the message from the receiver device after the message is displayed a length of time equivalent to the lifespan selected on the sender device.

(2) In another variant of the method for controlling the lifespan of a message, selecting a lifespan comprises selecting an icon displayed on the sender device causing it to toggle between two or more states indicating different respective lifespan times. When a message is sent with the icon toggled into a state corresponding to a lifespan, and the message is received by the receiver device, the message is displayed for a total length of time equivalent to the lifespan toggled on the sender device.

(3) In a further variant of the method for controlling the lifespan of a message, one of the states of the icon on the sender devices corresponds to instructing the messaging system to deliver to the message to the receiver device without automatically deleting the message after any predetermined amount of time. The message is stored on the receiver device until the message is deleted by a user of the receiver device.

(4) In still another variant of the method for controlling the lifespan of a message, the message comprises any one of audio, video, audio and video combined, text, and graphics.

(5) In yet another variant of the method for controlling the lifespan of a message, the message is obscured from view on the receiver device and is displayed and hidden from view at the option of a user of the receiver device. The total time the message is displayed is equivalent to the lifespan selected on the sender device.

(6) In a variant, the method for controlling the lifespan of a message comprises copying the message on the receiving device, during the lifespan of the message and the messaging system sending a message to the sender device notifying the sender device that the sent message was copied. Since the sender device desired that the message be only displayable for a predetermined length to time it is assumed that the copying was against the wishes of the sender and so notifying the sender assists the sender in maintaining control of its information.

(7) In another variant, a computer implemented messaging system for devices comprise a processor and a non transitory computer readable medium. The system comprises: a sender device; a receiver device; a messaging system operable on the sender and receiver devices. The messaging system comprises an input module on the sender device, configurable by a user of the sender device to select between at least two options for sending a message through the messaging system to the receiver device. The options comprise: after the message is received on the receiver device, automatically deleting the message after a predetermined amount of time the message is displayed either continuously or intermittently on the receiver device; and after the message is received on the receiver device, storing the message on the receiver device until a user of the receiver device deletes the message.

(8) In a further variant of the computer implemented messaging system for devices, the messaging system is configured to send a message to the sender device if the option to automatically delete the message after a predetermined amount of time is selected and the message is copied on the receiver device before the message is deleted.

(9) In yet another variant of the computer implemented messaging system for devices, the options for sending a message are embodied on the sender device as an icon that is changeable between at least two different states corresponding to the at least two options for sending a message through the messaging system.

(10) In still a further variant of the computer implemented messaging system for devices, the message comprises any one of audio, video, audio and video combined, text, and graphics.

(11) In a variant, the computer implemented messaging system for devices comprises a server configured to route a message from a sender device along with an associated selected option to the appropriate receiver device.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a diagram illustrating a system for controlling the lifespan of a message.

FIG. 2 is a flow chart illustrating one method for controlling the lifespan of a message.

FIG. 3 is a flow charge illustrating a variant of the method for controlling the lifespan of a message.

FIG. 4 is a flow chart illustrating another variant of the method for controlling the lifespan of a message.

FIG. 5 is a flow chart illustrating a further variant of the method for controlling the lifespan of a message.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention, in some embodiments thereof, relates to a method of controlling the lifespan of a message, and in one specific example, an MMS message (message sent via multimedia messaging service to and from mobile devices), and a notification to the sender if the lifespan of the MMS displayed on the mobile device is tampered with. In one example embodiment, to access the invention the sender and recipient alike must have a device compatible (Smart Phone, Tablet or Touch screen Computer or devices that act in the same manner) with our invention and register their details on the social network site.

Members invite individuals or group of individuals who have signed up on the social network site to join them for the purpose of communicating and socializing through the safe delivery of MMS. All MMS and other information about each member is stored in their personal Account on the cloud based platform or remote server. To access any information or to receive and send any new MMS using the invention, the member must be logged onto the social network site.

The present invention may operate in a social network environment and give members the option to have their MMS erased after being viewed or allowed to be saved by the recipient. Components of the invention may be accessed at the time of the composition of the MMS. The sender chooses who or to whom the MMS is being sent and before the MMS is sent, the sender activates an icon on the screen (in one example, a padlock—red padlock means saved to recipient—black padlock means deleted after being viewed) of their device to instruct the social network provider to either have the MMS erased or allow it to be saved by the recipient.

In a variant, any attempt by the receiver to not adhere to the instructions and wishes of the sender, (in this case to delete after being viewed), all parties, the receiver, sender and the social network provider are notified of the breach in real time and the receiver is flagged and asked to rectify the breach under the terms and conditions set down by the social network provider.

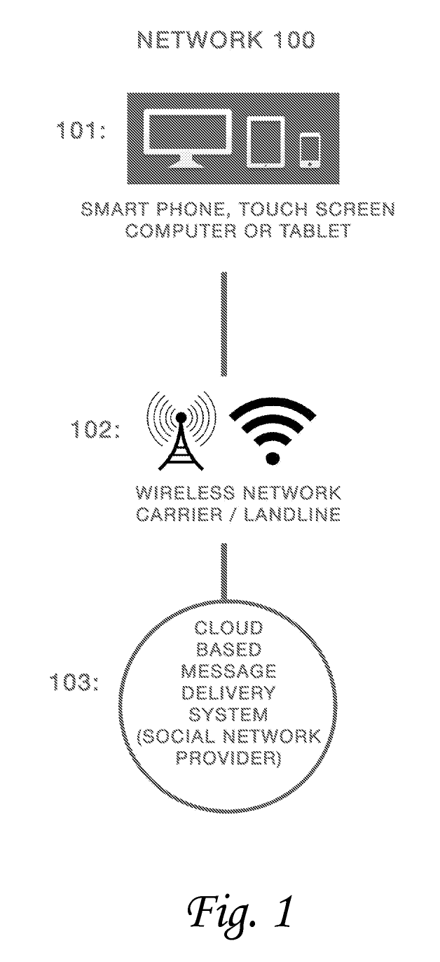

Referring to FIG. 1, a network 100 is illustrated, depicting sending an MMS in accordance with an embodiment of the present invention. The network 100 includes user devices 101, the carrier, wireless and landline networks 102 and a cloud based or remote server MMS delivery system 103. User devices 101 used in this communication are commonly a smart phone, tablet or touch screen computer. Notwithstanding, one skilled in the art may adapt any communication device with the same capabilities as the devices 101. Similarly, the network 102 may commonly be a wireless network but one skilled in the relevant art may adapt user devices to include wired networks or other wireless technologies. A message delivery system (for example, a social network provider) 103 receives MMS communication and instructions and delivers it to the intended recipients.

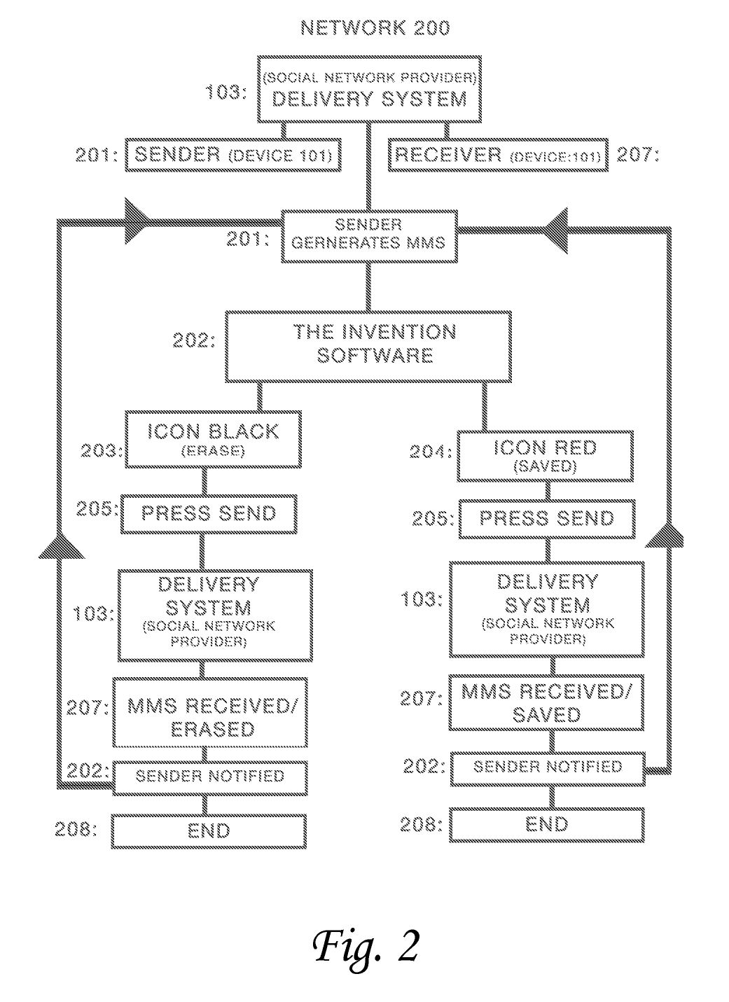

In a variant, referring to FIG. 2, a network 200 is illustrated and a sequence of events that take place in accordance with embodiments of the invention. In a step, both sender 201 and receiver 207 must be logged onto message delivery system 103 using devices 101. In a step, decides in accordance with the embodiment of the invention, sender 201 composes an MMS to be sent to a receiver 207 and it is at this point sender 201 decides what message an instructions icon 202 should deliver to the message delivery system 103. Instructions icon 202 may be, in one example, either black 203 or red 204 and a sender may toggled back and forth between black and red by pressing the instructions icon 202. When instructions icon 202 is black 203 and a message is sent, the message delivery system 103, in accordance with one embodiment of the invention, is instructed to delete the MMS after it has been viewed by receiver 207. In one example, the MMS is deleted within a predetermined amount of time. When instructions icon 202 is red 204, in accordance with one embodiment of the invention, the message delivery system 103 is instructed to save it to the receiver 207. In one example, receiver 207 may delete the MMS at his leisure. When sender 201 has chosen the appropriate command by toggling the desired color of the instructions icon 202 under which to send a message to the message delivery system 103, the sender 201 may press send icon 205. When a message is received by receiver 207 in accordance with instructions icon 202 have been completed successfully, sender 201 is notified by message delivery system 103 and the process ends 208.

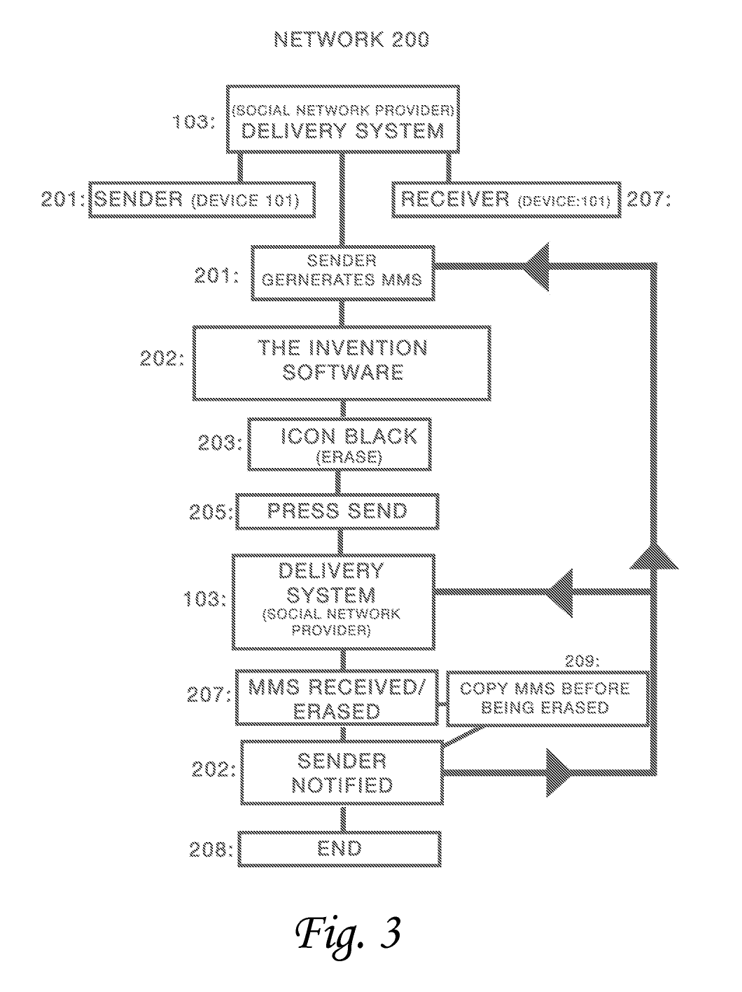

In another variant, referring to FIG. 3, a network 200 is illustrated that upon which a sequence of events take place in accordance with embodiments of the invention. Both sender 201 and receiver 207 must be logged onto message delivery system 103 using user devices 101. Sender 201 composes an MMS to be sent to a receiver 207 and it is at this point sender 201, in accordance with an embodiment of the invention, decides what message an instructions icon 202 should deliver to the message delivery system 103 to act upon. In accordance with an embodiment of the invention, instructions icon 202 may be toggled between either black 203 or red 204. When instructions icon 202 is selected to be black 203, the message delivery system 103 is instructed to delete the MMS, in accordance with the embodiment of the invention, after it has been viewed by receiver 202. When icon 202 is red 204 the message delivery system 103 is instructed, in accordance with one embodiment of the invention, to save it to the receiver 207. When sender 201 has chosen the appropriate command (red 204 or black 203) to send to message delivery system 103 with a MMS, the sender 201 may press send icon 205. In one example, receiver 207 has copied or attempted to copy MMS 209 instructed by icon 202 black 203 to be deleted by system 103. At this point, in accordance with an embodiment of the invention, both sender 201 and message delivery system 103 are notified of this breach and the process may end 208.

In a step 305, both sender 201 and receiver 207 must be logged onto message delivery system 103 using devices 101. In a step 310, sender 201 composes an MMS to be sent to a receiver 207 and it is at this point sender 201 decides in accordance with the embodiment of the invention what instructions icon 202 should deliver to the message delivery system 103 to act upon.

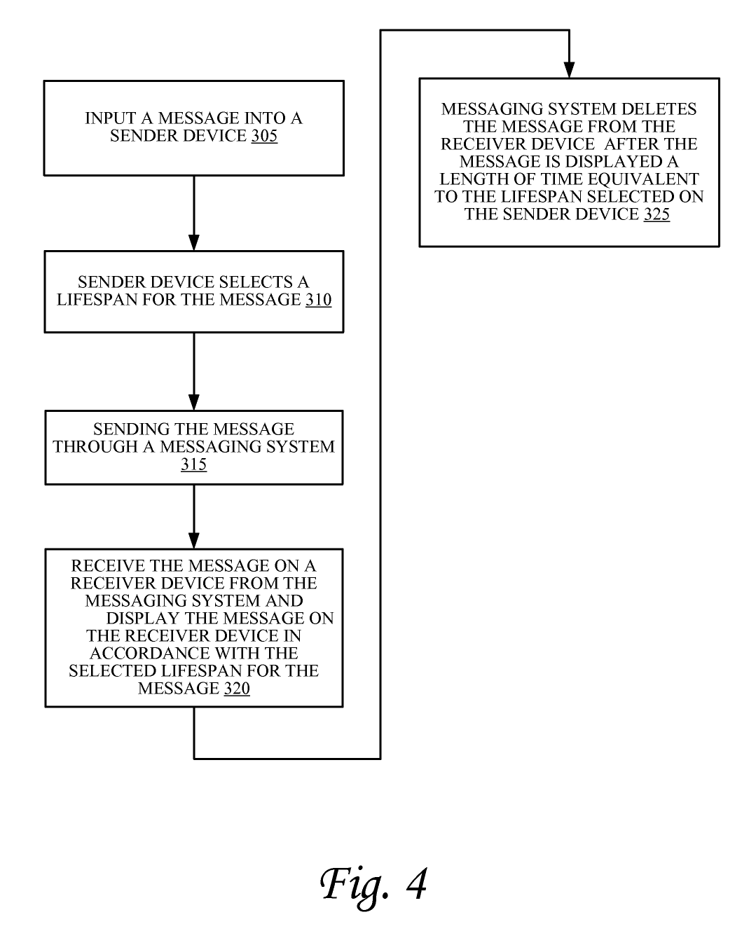

In a further variant, referring to FIG. 4, a computer implemented method for controlling a lifespan of a message sent from mobile devices, wherein the devices comprise a processor and a non transitory computer readable medium, comprises: in a step 305 inputting a message into a sender device; in a step 310 selecting a lifespan for the message, the lifespan comprising a predetermined time the message is displayable at a receiver device, wherein the selection of the lifespan is optionally performed on the sender device. Optionally, the selection is performed on another device, for example, a work station, a tablet or other network connected device connected to the messaging network. In a step 315, the method includes sending the message through a messaging system; in a step 320, receiving the message on a receiver device from the messaging system and displaying the message on the receiver device in accordance with the selected lifespan for the message. In a step 325, the messaging system deletes the message from the receiver device after the message is displayed a length of time equivalent to the lifespan selected on the sender device.

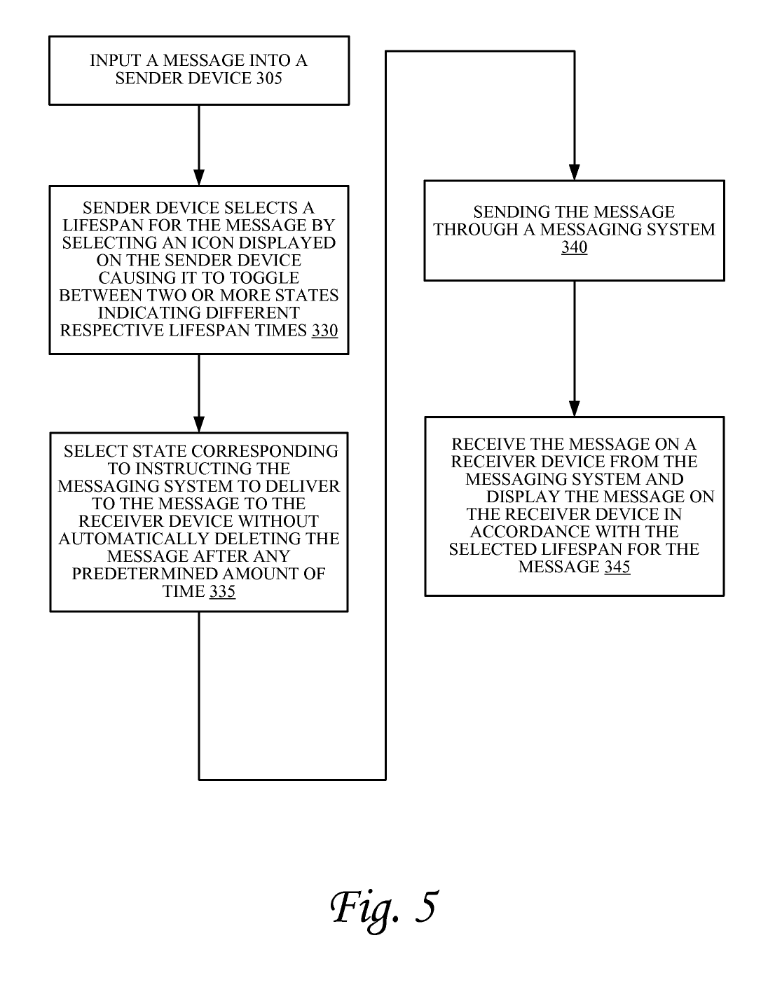

In another variant of the method for controlling the lifespan of a message, referring to FIG. 5, selecting a lifespan comprises, in a step 330 selecting an icon displayed on the sender device causing it to toggle between two or more states indicating different respective lifespan times. When a message is sent with the icon toggled into a state corresponding to a lifespan, and the message is received by the receiver device, the message is displayed for a total length of time equivalent to the lifespan toggled on the sender device.

In a further variant of the method for controlling the lifespan of a message, one of the states of the icon on the sender devices corresponds to, in a step 335 instructing the messaging system to deliver to the message to the receiver device without automatically deleting the message after any predetermined amount of time. The message is stored on the receiver device until the message is deleted by a user of the receiver device. In a step 340, the method includes sending the message through a messaging system; and in a step 345, receiving the message on a receiver device from the messaging system and displaying the message on the receiver device in accordance with the selected lifespan for the message.

In still another variant of the method for controlling the lifespan of a message, the message comprises any one of audio, video, audio and video combined, text, and graphics.

In yet another variant of the method for controlling the lifespan of a message, the message is obscured from view on the receiver device and is displayed and hidden from view at the option of a user of the receiver device. The total time the message is displayed is equivalent to the lifespan selected on the sender device.

In a variant, the method for controlling the lifespan of a message comprises copying the message on the receiving device, during the lifespan of the message and the messaging system sending a message to the sender device notifying the sender device that the sent message was copied. Since the sender device desired that the message be only displayable for a predetermined length to time it is assumed that the copying was against the wishes of the sender and so notifying the sender assists the sender in maintaining control of its information.

In another variant, a computer implemented messaging system for devices comprise a processor and a non transitory computer readable medium. The system comprises: a sender device; a receiver device; a messaging system operable on the sender and receiver devices. The messaging system comprises an input module on the sender device, configurable by a user of the sender device to select between at least two options for sending a message through the messaging system to the receiver device. The input module may be a microphone, a text box field, or another type of message input mechanism. The options comprise: after the message is received on the receiver device, automatically deleting the message after a predetermined amount of time the message is displayed either continuously or intermittently on the receiver device; and after the message is received on the receiver device, storing the message on the receiver device until a user of the receiver device deletes the message.

In a further variant of the computer implemented messaging system for devices, the messaging system is configured to send a message to the sender device if the option to automatically delete the message after a predetermined amount of time is selected and the message is copied on the receiver device before the message is deleted.

In yet another variant of the computer implemented messaging system for devices, the options for sending a message are embodied on the sender device as an icon that is changeable between at least two different states corresponding to the at least two options for sending a message through the messaging system.

In still a further variant of the computer implemented messaging system for devices, the message comprises any one of audio, video, audio and video combined, text, and graphics.

In a variant, the computer implemented messaging system for devices comprises a server configured to route a message from a sender device along with an associated selected option to the appropriate receiver device.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method for controlling a lifespan of a message sent from mobile devices, wherein the devices comprise a processor and a non transitory computer readable medium, the method comprising:
inputting a message into a sender device;
selecting a lifespan for the message, the lifespan comprising a predetermined time the message is displayable at a receiver device, wherein the selection of the lifespan is performed on the sender device;
sending the message through a messaging system;
receiving the message on a receiver device from the messaging system; and
displaying the message on the receiver device in accordance with the selected lifespan for the message;
wherein the messaging system deletes the message from the receiver device after the message is displayed a length of time equivalent to the lifespan selected on the sender device.

2. The method for controlling the lifespan of a message of claim 1, wherein selecting a lifespan comprises selecting an icon displayed on the sender device causing it to toggle between two or more states indicating different respective lifespan times;
wherein when a message is sent with the icon toggled into a state corresponding to a lifespan, and the message is received by the receiver device, the message is displayed for a total length of time equivalent to the lifespan toggled on the sender device.

3. The method for controlling the lifespan of a message of claim 2, wherein one of the states of the icon on the sender devices corresponds to instructing the messaging system to deliver to the message to the receiver device without automatically deleting the message after any predetermined amount of time;
wherein the message is stored on the receiver device until the message is deleted by a user of the receiver device.

4. The method for controlling the lifespan of a message of claim 1, wherein the message comprises any one of audio, video, audio and video combined, text, and graphics.

5. The method for controlling the lifespan of a message of claim 1, wherein the message is obscured from view on the receiver device and is displayed and hidden from view at the option of a user of the receiver device, wherein the total time the message is displayed is equivalent to the lifespan selected on the sender device.

6. The method for controlling the lifespan of a message of claim 1, further comprising copying the message on the receiving device, during the lifespan of the message; and
the messaging system sending a message to the sender device notifying the sender device that the sent message was copied.

7. A computer implemented messaging system for devices comprising a processor and a non transitory computer readable medium, the system comprising:
a sender device;
a receiver device;
a messaging system operable on the sender and receiver devices, the messaging system comprising:
an input module on the sender device, configurable by a user of the sender device to select between at least two options for sending a message through the messaging system to the receiver device, the options comprising:
after the message is received on the receiver device, automatically deleting the message after a predetermined amount of time the message is displayed either continuously or intermittently on the receiver device; and
after the message is received on the receiver device, storing the message on the receiver device until a user of the receiver device deletes the message.

8. The computer implemented messaging system for devices of claim 7, wherein the messaging system is configured to send a message to the sender device if the option to automatically delete the message after a predetermined amount of time is selected and the message is copied on the receiver device before the message is deleted.

9. The computer implemented messaging system for devices of claim 7, wherein the options for sending a message are embodied on the sender device as an icon that is changeable between at least two different states corresponding to the at least two options for sending a message through the messaging system.

10. The computer implemented messaging system for devices of claim 7, wherein the message comprises any one of audio, video, audio and video combined, text, and graphics.

11. The computer implemented messaging system for devices of claim 7, further comprising a server configured to route a message from a sender device along with an associated selected option to the appropriate receiver device.
